(19) United States
(12) Patent Application Publication
(10) Pub. No.: US 2006/0093195 A1
(43) Pub. Date: May 4, 2006

(54) Method for analysing images

(75) Inventor: Justian Craig Fox, Slough (GB)

Correspondence Address: PALMER & DODGE, LLP;KATHLEEN M. WILLIAMS, 111 HUNTINGTON AVENUE, BOSTON, MA, 02199, US

(73) Assignee: Argenta Discovery Limited

(21) Appl. No.: 11/239,499

(22) Filed: Sep. 29, 2005

Related U.S. Application Data
(63) Continuation of application No. PCT/GB04/01348, filed on Mar. 29, 2004.

(30) Foreign Application Priority Data
Apr. 1, 2003 (GB) 0307537.1

(51) Int. Cl. G06K 9/00

(52) U.S. Cl. 382/128

(57) ABSTRACT

The invention relates to computer-based methods for lung morphometric analysis, employing Linear Mean Intercept (LMI), Surface Area to Volume (S/V) ratios, and mean branch length parameters to define lung emphysema.

### RELATED APPLICATIONS

This application is a continuation of International Application Number PCT/GB2004/001348, filed Mar. 29, 2004, which claims priority to Great Britain Application Number 0307537.1, filed on Apr. 1, 2003, the entirety of all these applications are hereby incorporated herein by reference.

### FIELD OF THE INVENTION

The present invention relates to a method for the automated analysis of tissue morphology. In particular, the method of the invention relates to a computer-based analysis of lung tissue, for the detection of, for example, pulmonary emphysema.

### BACKGROUND

In humans, the surface area of the lung is approximately 130 m², which is packed into the limited space of the chest cavity (around 5-6 litres). The internal lung surface is a highly folded membrane that allows the organ to be very efficient at gaseous exchange, with around 300,000,000 alveoli all open to outside air (1). This relationship of lung structure to function is highly conserved and a change in respiratory function will often be reflected in lung structure. For this reason lung morphometry has been widely used in the study of lung disease and dysfunction. Examples include bronchopulmonary dysplasia (2), pulmonary fibrosis (3) and pulmonary emphysema (4).

Pulmonary emphysema is defined as abnormal and permanent enlargement of the airspaces distal to the terminal bronchioles, accompanied by destruction of their walls without obvious fibrosis (5). Examination of thin slices from emphysematous lungs reflects this definition (FIG. 1), and the severity of emphysema observed from such slices, has been commonly evaluated by calculating the average distance between alveolar walls (Lm) (6, 7). An increasing Lm value reflects increasing airspace size which in turn, is a feature of more severe emphysema (8).

Thin slices of tissue are two-dimensional but the microstructures that they sample are three-dimensional. Stereological techniques allow inferences about three-dimensional geometric properties of these structures to be made from measurements made on two-dimensional slices. Various stereological techniques for lung structure morphometry have been described, including volume estimation by the Cavalieri method (9), and surface area to volume ratio estimation using a graticule (10). Structure specific measurements such as number and volume of alveoli have also been described (11). Emphysema in man has also been examined using stereological techniques on thin sections of lung after autopsy (12).

Various animal models of emphysema exist which provide the opportunity for potential therapeutic agents to be evaluated (13), and morphological techniques have been employed to address the validity of these models. Exposing the lungs to a protease such as elastase (14) or papain (15) is a common method for inducing emphysema. Cigarette exposure is known to cause emphysema in humans (16) and has consequently been tested in animal models. In both mice and rat models emphysematous lesions have been observed in response to cigarette smoke (17, 18). A recent study suggests that the effect in mice occurs quicker than in rats, and in mice the emphysema may be progressive (19). Interestingly, cigarette smoke has been shown to augment the elastase-induced emphysema in rats (20) which indicates the presence of more than one mechanism for the initiation of emphysematous lesion formation.

Stereological methods and Lm measurement are inherently labour intensive and time consuming, often taking up to forty-five minutes per section (21). To be used routinely in research, a morphometric technique would have to be much quicker than 45 minutes per section and be effort-efficient. There is therefore a need in the art for improved morphometry techniques.

### SUMMARY OF THE INVENTION

A recent advancement in lung morphometry is the application of image analysis using computers (22, 23). We have now developed a rapid, computer-based method using multiple parameters to provide an improved morphometric analysis which can be automated.

In accordance with the invention, therefore, there is provided a method of analysing a sample image representing a sample of lung, said method comprising: forming an applied graticule image corresponding in size to said sample image and excluding areas corresponding to non-parenchyma within said sample image; superimposing said applied graticule image on said sample image; determining one or more parameters dependent upon which portions of said applied graticule image fall in airspace and which portions of said applied graticule image fall upon tissue; and calculating a parameter indicative of a surface to volume ratio for said sample of lung from said one or more parameters.

A “sample image” is an image of lung tissue which is obtained by the image analyser and used to perform the morphometric analysis as described herein. The sample image may be of the whole lung or part of the lung. Typically, it is of part of then lung. The sample image is advantageously a composite image, made up of two or more images of lung tissue taken from different parts of the lung.

A “lung sample” is the part of the lung which is used to obtain the sample image. It may be a section of lung, a tissue specimen or biopsy, or a whole lung, and may be imaged in vitro or in viva.

A “graticule” is a grid, mesh or other means to divide an image area into a plurality of sections, which may be regular or irregular in shape. Advantageously, the graticule divides the image into a series of regular sub-sections, for example squares.

“Airspace” means the space at the interior of alveoli or other air-filled spaces in the lung. In a tissue section, it refers to the gaps between tissue where air would be present in vivo, regardless of whether air is so present in the section itself as analysed.

In an advantageous embodiment, the applied graticule image is formed by the steps of: identifying non-parenchyma areas of said sample image corresponding to tissue other than parenchyma; Forming a full frame graticule image corresponding in size to said sample image; and removing from said full frame graticule image areas corresponding to said non parenchyma areas to forth said applied graticule image.

Preferably, the step of identifying comprises the steps of: searching said sample image for areas of tissue greater than a predetermined size; classifying said areas of tissue greater than a predetermined size as non-parenchyma areas.

User input may also be exploited to improve the identification procedure.

The parameters measured in the method of the invention preferably include one or more of:

a number Iₐ of graticule lines of said applied graticule image intersecting tissue;

and

a number Pₐ of ends of graticule lines on airspace.

This means that the surface to volume ratio can be calculated as being proportional to:
(Iₐ*2)/(Pa*L_{T})
where L_{T} represents a length of a graticule line.

In a second aspect, the invention provides a method of analysing a sample image representing a sample of lung, said method comprising: identifying non-parenchyma areas of said sample image corresponding to tissue other than parenchyma; searching within areas of said sample image corresponding to parenchyma for bounded areas of airspace surrounded by tissue; measuring a perimeter value and an area value for said bounded areas; and calculating a parameter indicative of a surface to volume ratio for said sample of lung from said perimeter value and said area value.

Parenchyma can be identified as set forth in the foregoing aspect of the invention. Preferably, bounded areas having an area smaller than a predetermined threshold value are excluded from the calculating step.

According to the second aspect of the invention, perimeter value can be a total perimeter value P_{T} for said bounded areas upon which said calculation is based and said area value can be a total area value A_{T} for said bounded areas upon which said calculation is based. The surface to volume ratio can thus be calculated as being proportional to:
(4*P_{T})/(π*A_{T})

In a third aspect, the invention provides a method of analysing a sample image representing a sample of lung, said method comprising: forming an applied lines image of a plurality of substantially parallel lines and corresponding in size to said sample image and excluding areas corresponding to non parenchyma within said sample image; superimposing said applied lines image on said sample image; determining where lines of said applied lines image intersect tissue within said sample image to form intersected line segments; and calculating a parameter indicative a mean length of said intersected line segments.

The steps of forming, superimposing, determining and calculating can be repeated for one or more further applied lines images of lines running in a different direction. For example, the different direction can be substantially orthogonal.

Advantageously, the method further comprises calculating a parameter indicative of a distribution of lengths of said intersected line segments.

Preferably, said applied lines image is formed by the steps of: identifying non-parenchyma areas of said sample image corresponding to tissue other than parenchyma; forming a full frame lines image corresponding in size to said sample image; and removing from said full frame lines image areas corresponding to said non parenchyma areas to form said applied lines image.

Parenchyma and non-parenchyma can be identified as set forth above.

In a fourth aspect of the present invention, there is provided a method of analysing a sample image representing a sample of lung, said method comprising: identifying non-parenchyma areas of said sample image corresponding to tissue other than parenchyma; searching within areas of said sample image corresponding to parenchyma for nodes corresponding to ends of branches in tissue of said sample lung; calculating a parameter indicative of a straight line distance between nodes at ends of branches of tissue of said sample of lung; and calculating a parameter indicative of a distance measured along said branches between nodes at ends of branches of tissue of said sample of lung.

Parenchyma and non-parenchyma can be identified as above. Preferably, areas of tissue within said sample image are thinned prior to said step of searching.

Advantageously, the steps of searching include applying a convolution to said sample image.

Preferably, the nodes are removed from said sample image to leave disconnected branches of tissue.

In accordance with a fifth aspect, the invention provides a method of analysing a sample image representing a sample of lung, said method comprising: analysing said sample of lung according to the methods set forth in any of the four preceding aspects of the invention to allow two or more of Linear Mean Intercept (LMI), Surface Area to Volume (S/V) ratios, and mean branch length to be calculated; and combining the results of said methods to produce a measure of lung emphysema.

Advantageously, the method according to the fifth aspect of the invention combines all four of the preceding aspects of the invention.

The invention further provides a computer program product including a computer program for controlling a computer to perform a method as described in the foregoing aspects of the invention, as well as an apparatus for analysing a sample image representing a sample of lung, said apparatus comprising data processing logic operable to perform data processing operations in accordance with a method as described in the foregoing aspects of the invention.

### BRIEF DESCRIPTION OF THE DRAWINGS

FIG. 1. Thin sections from human lung illustrating the morphological difference observed when comparing normal to emphysematous lungs. Low power light microscopy images of human lung obtained from thin sections. Normal lung (A) contains regular size alveoli and alveolar ducts, whereas emphysematous lungs present damaged alveoli and airspace expansion (B).

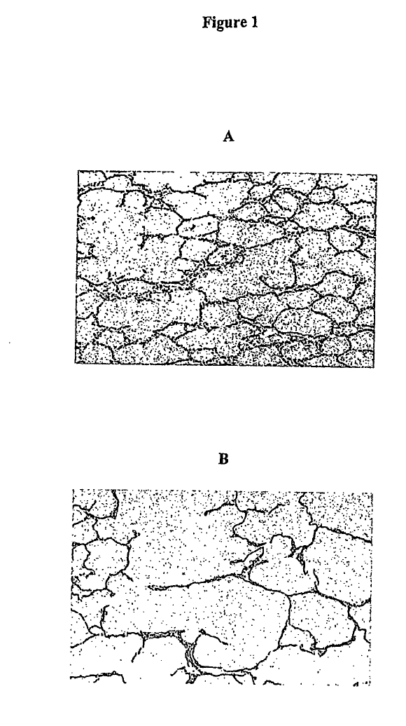

FIG. 2. Image showing the mosaic macro in progress. Images are captured in a raster fashion and each field of view is saved separately. In addition a reference mosaic image (above) is generated which shows the whole area of capture. Typically between 150 and 300 field of view images are required for a whole slice from an adult rat to be captured.

FIG. 3. Single field of view image captured during the mosaic process.

FIG. 4. 3×3 image generated from 9 images captured during the mosaic process.

FIG. 5. Six 3×3 images are randomly chosen by the computer using the reference mosaic image.

FIG. 6. Inverted 3×3 image—lung tissue is brighter shall the rest of the image.

FIG. 7. 3×3 binary image after dynamic discrimination segmentation and bin scrap.

FIG. 8. Automated detection of blood vessels and other solid tissue components (shown in green, with original 3×3 as reference).

FIG. 9. Remaining non-parenchyma components identified manually by outlining in green on the image using a digital pen by the user.

FIG. 10. Non-parenchyma component ‘b’ image.

FIG. 11. A multipurpose test grid first proposed by Weibel for calculation of S/V Ratios (25).

FIG. 12. Weibel Graticule with linear dimensions indicated (10).

FIG. 13. Image showing past of the grid when merged with the ‘b’ image—removing lines that would cover non-parenchyma components.

FIG. 14. After image merging only lines not intersecting tissue are left.

FIG. 15. Image merging procedure is repeated for the ends of the lines leaving only ends that fall on airspace.

FIG. 16. Region determination resulting in area and perimeter measurements.

FIG. 17. Calculation of the Lm by counting the number of intersections of the parallel lines with the interalveolar septa and dividing this by the total length of the lines used (6).

FIG. 18. One pixel thick lines 10 pixels apart drawn on a blank 3×3 and then merged with the ‘b’ image to leave lines that will only lie over parenchyma.

FIG. 19. LMI grid image merged with lung ‘a’ image resulting in interalveolar intercepts.

FIG. 20. Overlay of the full LMI grid on a lung section.

FIG. 21. Thinning of the lung structure resulting in a skeleton-like appearance of the lung parenchyma. Original lung binary image (4) is thinned and then smoothed leaving a skeleton structure (B).

FIG. 22. Branch structure overlaid on top of original lung binary image (individual branches shown in different colours).

FIG. 23. Effect of PPE on lung morphology. Airspaces are greatly enlarged after PPE treatment (B) resulting in emphysematous morphology compared to that of normal rat lung (A).

FIG. 24. Surface to Volume ratios of adult rat lungs following a single instillation of saline or PPE and examined 28 days later. S/V ratios were calculated by using a Weibel l O graticule (A) or perimeter/area based measurements (B) (see methods).

FIG. 25. Significant effect of PPE treatment on the linear mean intercept (LMI).

FIG. 26. Normalised distribution of intercept lengths from LMI analysis. PPE treatment causes a decrease in small and an increase in large intercepts.

FIG. 27. Significant effect of PPE on mean node-to-node distance and mean branch length determined by nodal analysis (see methods).

FIG. 28. Normalised distribution of branch lengths from node analysis. PPE treatment causes a decrease in small branches and an increase in large branches.

FIG. 29. Relationship between S/V ratio (Weibel Graticule with 15 pixel lines) and LMI in all rats examined. S/V ratio is inversely proportional to LMI.

FIG. 30. Flow chart of the computer-implemented method of the invention.

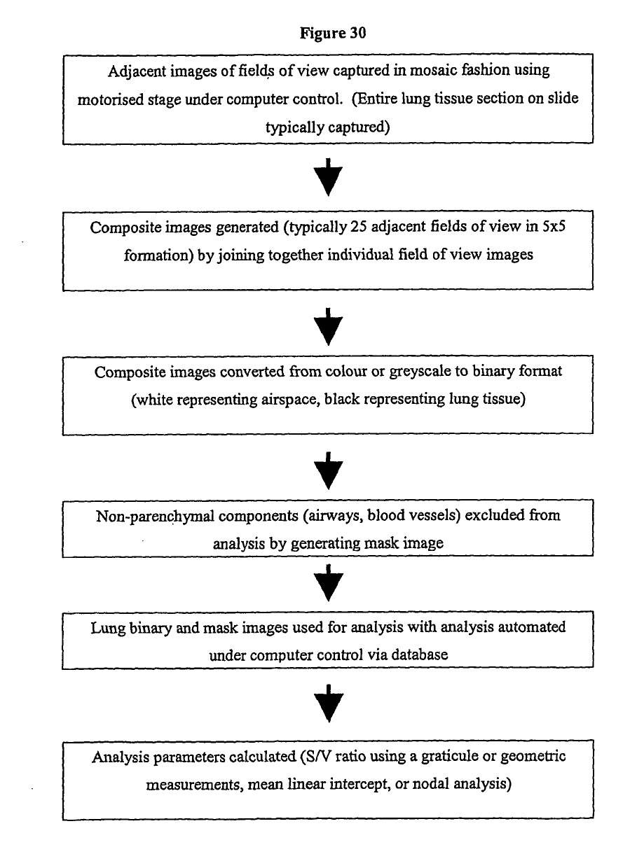

### DETAILED DESCRIPTION

1. General Techniques

Unless defined otherwise, all technical and scientific terms used herein have the same meaning as commonly understood by one of ordinary skill in the art (e.g., in cell culture, molecular genetics, nucleic acid chemistry, hybridisation techniques and biochemistry). Standard techniques are used for molecular, genetic and biochemical methods (see generally, Sambrook et al., Molecular Cloning: A Laboratory Manual, 2d ed. (1989) Cold Spring Harbor Laboratory Press, Cold Spring Harbor, N.Y. and Ausubel et al., Short Protocols in Molecular Biology (1999) 4^{th} Ed, John Wiley & Sons, Inc. which are incorporated herein by reference) and chemical methods. In addition Harlow &Lane, A Laboratory Manual Cold Spring Harbor, N.Y., is referred to for standard Immunological Techniques.

2. Materials and Methods

2.1 Animals and Intratracheal Instillations

Porcine pancreatic elastase (PPE) (600 units in 0.5 ml), or an equal volume of saline (to serve as controls), was instilled transorally into the trachea of anaesthetised adult (250-300 g) male Spraque-Dawley rats using a Penn Century micro-sprayer. The rats were monitored for 24 hrs for signs of distress and approximately 25% had to be sacrificed due to the severity of their reaction to the elastase. The remaining animals were killed 28 days later for assessment of emphysema.

2.2 Fixation, Tissue Sampling, and Tissue Preparation

The rats were killed with an overdose of sodium pentobarbital (˜0.5 ml of a 0.8 M solution i.p.). The diaphragm was punctured after intubation of the trachea and the lungs inflated with phosphate-buffered formalin (PBF) at a transpulmonary pressure of 20 cm H₂O. The trachea was ligated, the lungs removed from the thorax and stored in PBF for 48 hours at 4° C. The left and right lungs were separated and a longitudinal section ˜7 mm thick was cut from the middle of the left lobe. This was dehydrated through an ethanol gradient and embedded in paraffin wax using a TissueTek processor. After facing the block, 4 μm sections were cut and mounted on slides. The wax was removed with xylene and the tissue stained with haematoxylin and eosin (H&E).

2.3 Technical Equipment

A Leica DMR microscope fitted with a ×10 objective was used to view the lung slides. A JVC 3-CCD colour video camera (RGB-PAL) was fitted to the microscope to allow image capture. A Prior motorised stage allowed computer controlled navigation of the field of view in the x and y axis. Image capturing and analysis was carried out by Carl Zeiss KS400 image analysis software (Imaging Associates, Thame, UK) on a Compaq Deskpro EN series PC (256 MB of RAM, Intel Pentium III 600 MHz processor) running Microsoft Windows NT 4.

The KS400 software contains a command line interpreter, enabling user-defined macros to be written and implemented. Macros referred to in the text are presented in the appendix.

2.4 Image Capture

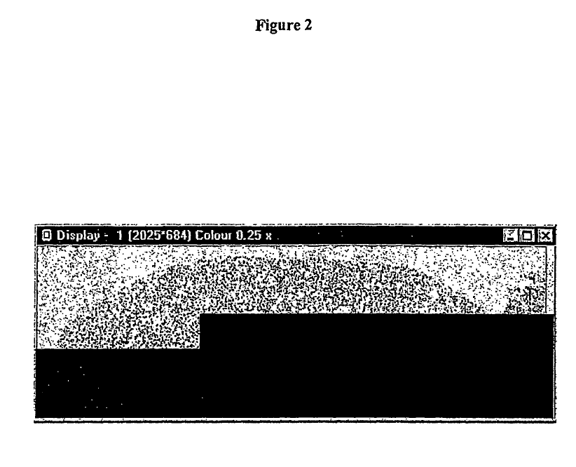

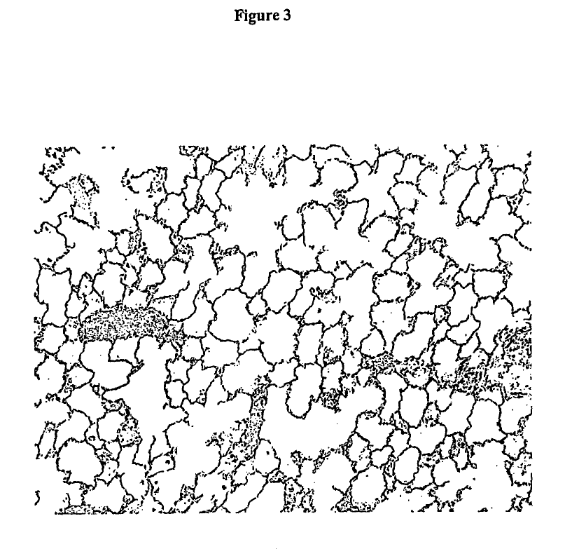

A longitudinal whole lobe slice from an adult rat typically covers a large area of a standard microscope slide; especially if the lung has been exposed to PPE and the lung is enlarged. Images of the lobe are captured using the “Mosdefine” macro (FIG. 2). The four corners of the area to be scanned (the whole lobe slice) are defined by moving the field of view to these positions and the co-ordinates are automatically recorded. Under computer control the camera grabs an image of the current field of view and then the stage moves the slide so that the next field of view is adjacent to the previous one. This process is continued in a raster fashion until the whole lobe is captured. Typically between 150 and 300 images are grabbed for an adult rat lobe slice. Grey rather than colour images are saved to preserve hard disc space. The lung tissue appears dark compared to the airspace (FIG. 3). The final on-screen magnification using the ×10 objective is approximately ×300.

2.5 3×3 Image Selection

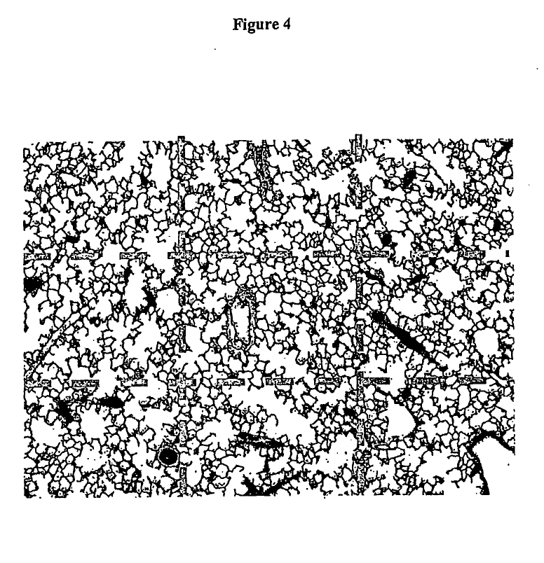

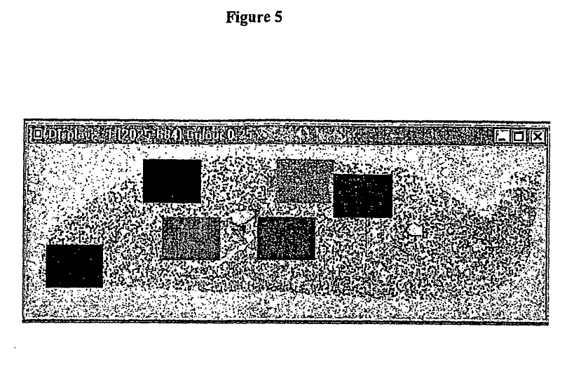

Due to the lobe slice being large, a single field of view represents a small proportion of the total area and may be unrepresentative of the whole lobe. For this reason, 9 fields of view are later joined together in a 3×3 formation to provide a larger area of the lobe for analysis (FIG. 4). For each lobe, six 3×3 images were randomly chosen by running another macro “3×3sel” which randomly highlights 3×3 areas on the mosaic reference image (FIG. 5). The user accepts the area as long as the area covers at least 40% lung tissue. A database is created which records the identity of the 3×3 images that are to be created and analysed.

2.6 Image Processing

3×3 generation, segmentation, non-parenchyma component identification and image storage are achieved in one process by running the ‘RatX10proc’ macro. However this process has been broken down into separate components below for clarity.

2.6.1 3×3 Generation and Image Segmentation

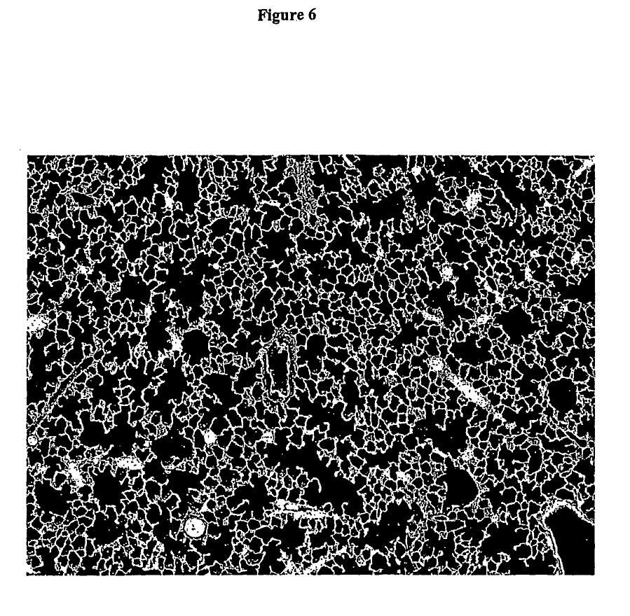

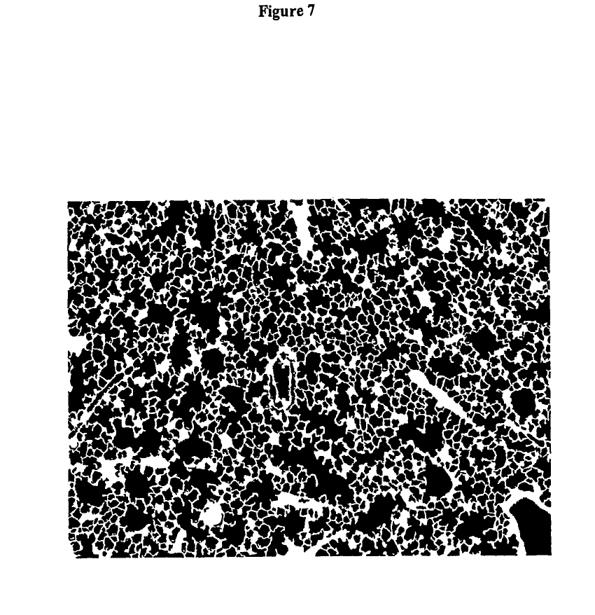

For any given 3×3, the system calculates which nine images are required, loads them into the memory, and then creates a 3×3 image from the nine individual images (FIG. 4). Images must be in a binary format before they can be analysed and the term used to describe the process of converting images into binary images is segmentation. This segmentation is achieved by thresholding grey levels. The dynamic discrimination function used sets a local grey threshold and this enables the system to look for objects that are brighter than the surrounding area. To accomplish this with our 3×3 grey images the image is inverted first (FIG. 6). This segmentation procedure requires no user input and so the same function is applied to all 3×3 images. On some images, noise is generated during the segmentation so a binary scrap function is applied which removes objects with an area below 200 pixels and results in a satisfactory binary image (FIG. 7).

2.6.2 Non-parenchyma Component Identification

Lung tissue is made up of many components such as alveoli, alveolar ducts, blood vessels, airways, bronchioles and airway ducts. Non-parenchyma components such as blood vessels and conductive airways are not randomly distributed in the lung (24) and therefore have the potential to influence the analysis. (Moreover, a large airway will be indistinguishable from a large emphysematous area from an analytical viewpoint). For these reasons non-parenchyma components are omitted from the analysis. This process is achieved in two stages: an automated step followed by a manual step.

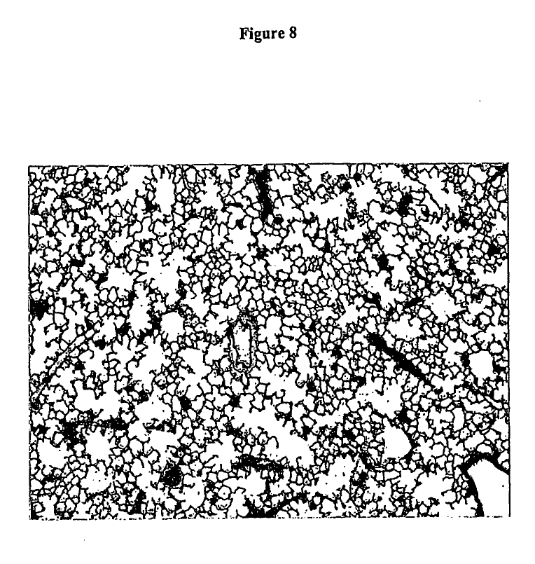

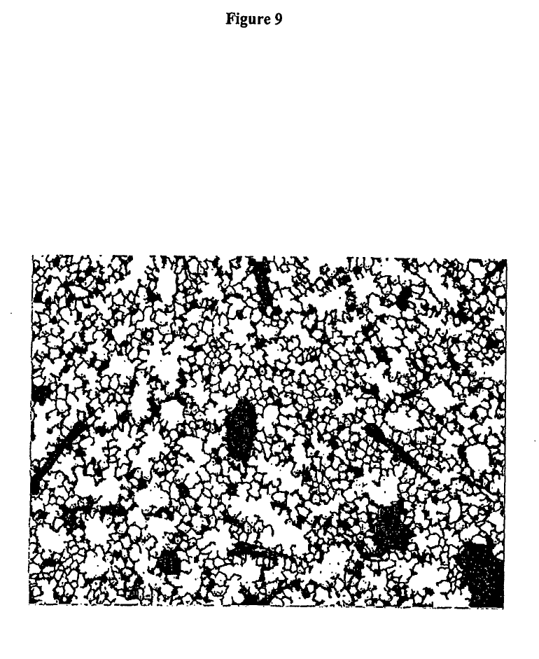

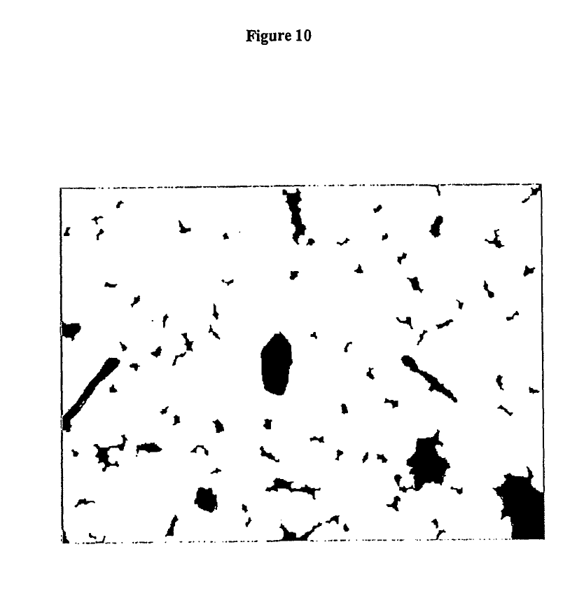

Blood vessels and other large areas of solid tissue (large areas of white on FIG. 7) can be identified automatically due to the size of the area they occupy. These areas are then projected on top of the 3×3 in green using an overlay (FIG. 8). This automatic step identifies tissue-based components but it cannot be used to identify large airways, as these: are indistinguishable from large airspaces. Therefore other non-parenchyma components not picked up by the automated step are identified manually using a digital pen by the user (FIG. 9). Features to be omitted from the analysis are stored as a new image (termed ‘b’ image) and this is created from the identified components previously illustrated in green (FIG. 10). From each 3×3 chosen for analysis two images are saved; an ‘a’ image containing the original lung architecture in binary form (FIG. 7), and a ‘b’ image containing the non-parenchyma components. This method allows preservation of the raw data (original image) while only permitting the parenchyma to be analysed.

This procedure is completed for each of the six 3×3 images. As the analysis process (detailed below) is fully automated, it is preferable to perform the 3×3 image generation process for other slides and build up a ‘bank’ of images to be analysed. The analysis can then be run overnight, for example.

2.7 Morphometric Analysis

We have adapted existing methods of lung morphometry into our analysis procedure along with implementing novel methods of our own. The four parameters we examine (graticule based S/V ratio, perimeter/area measurement based S/V ratio, linear mean intercept, and nodal analysis) are analysed sequentially by a macro ‘cmal’ and the resulting data is stored in one spreadsheet automatically for each slide. A description of each parameter is provided below.

2.7.1 Surface Area to Volume Ratio Using a Graticule

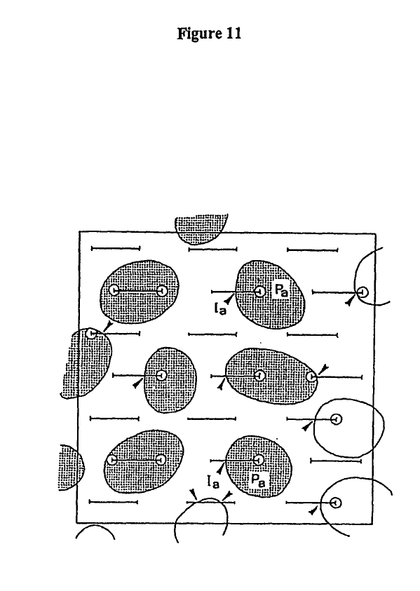

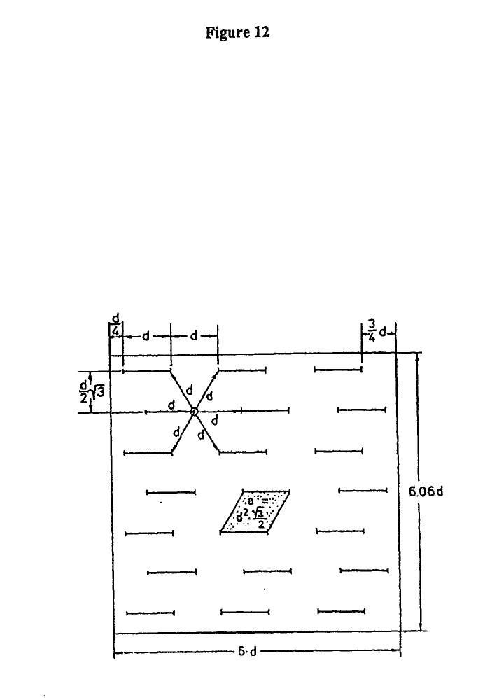

The Surface Area to Volume ratio can be calculated from point counting measurements made using a Weibel graticule (FIG. 11). The graticule is normally used either through the microscope eyepiece, or projected onto micrographs of lung sections. The grid test lines (probes) give an indication of the surface area by recording the number of intersections between airspace and tissue. The ends of these lines serve as references for volume. Using the inverse of a formula for Volume to Surface Area ratio (25) we have adapted this methodology to our computerised system. We decided to superimpose the graticule on the whole of our 3×3 image to give a large number of test lines/image. The Weibel graticule is made up of short test lines (length d) whose end points are arranged in a regular equilateral triangular lattice resulting in a rhombus lattice unit (FIG. 12). In order to construct this grid onto an image the dimensions of each line needed to be defined. The smallest units for images are picture elements (pixels) and these have to be integers as half a pixel cannot be drawn on the screen. Therefore both the length of the line d and the value resulting from [d/2√3] (distance between lines in the y-axis, referred to in the text as m) need to be integers. We empirically determined 15 and 30 as values for d, which gave integers for m as 13 (12.99), and 26 (25.98) respectively. The macro draws a line in the top left hand corner of a blank 3×3 image d pixels long in the x axis, moves along a further d pixels and draws another one. This is repeated until the right edge of the image is reached when the y position is incremented m pixels down and the starting x position becomes 0+d/2. The lines are then drawn as before until the right edge of the image is reached. The y position is incremented again m pixels down and the x position is reset to zero. Following repetition of this whole process the resultant image now contains a Weibel graticule, which covers the entire area of a 3×3. Both 15 and 30 pixel length lines are used, as both have (at ×300 magnification) a suitable length relative to the features of interest such as alveoli. The above method is then repeated to draw points representing the ends of the lines (e.g. for d=15, one pixel is drawn, 13 blank, one pixel drawn, 15 blank, one pixel drawn, 13 blank etc).

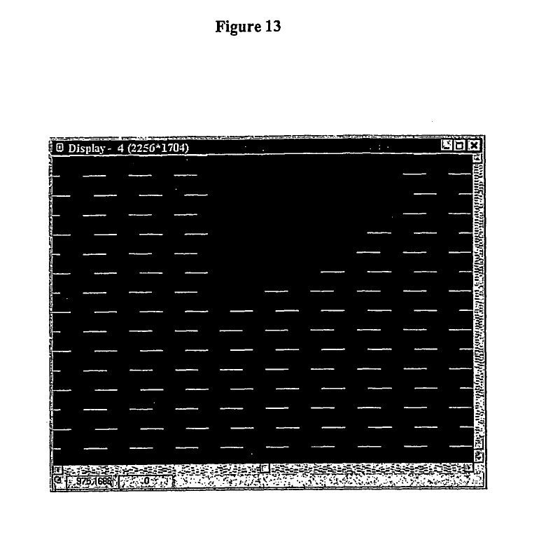

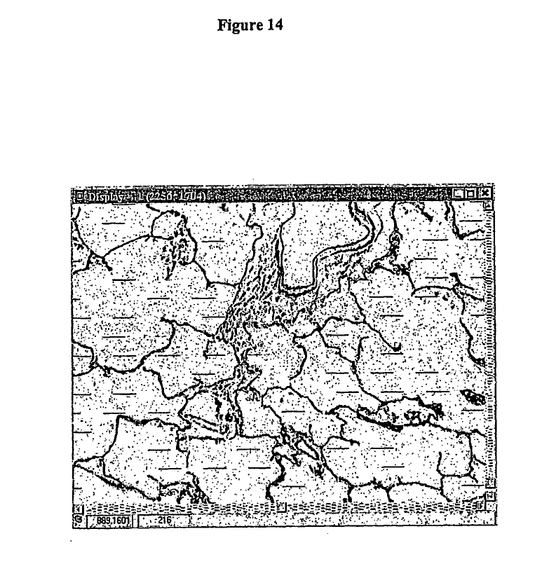

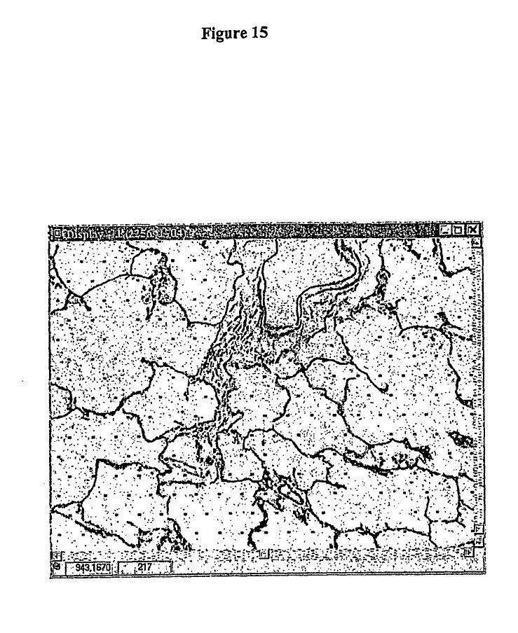

Once these images of lines and ends of lines are drawn they are merged with the ‘b’ image saved earlier for a particular 3×3. Only lines/ends of lines that did not touch components of non-parenchyma are left (FIG. 13). This leaves a grid that, when superimposed on the ‘a’ image, only covers parenchyma. Once this has been completed, the number of lines covering the parenchyma are counted automatically by the computer. This grid is then merged with the ‘a’ image (lung binary) and only lines that do not intersect tissue (fall on airspace) are left (FIG. 14). The number of lines left is then counted. In addition this process is carried out for the ends of the lines (FIG. 15). This results in four values being obtained: Total No. lines on parenchyma (I_{T}), No. lines not intersecting parenchyma tissue (Iₛ), Total No. ends of lines on parenchyma (P_{T}), and No. ends of lines on parenchyma airspace (Pₐ).

The formula for calculating the S/V ratio is: Iₐ×2/Pₐ×L_{T} (25), where Ia is number of lines intersecting the tissue (I_{T}−Iₛ), and L_{T} is the length of an individual line on the grid (d). To obtain the S/V ratio in cm⁻¹ L_{T} is converted from pixels to cm.

2.7.2 Surface Area to Volume Ratio from Perimeter/Area Measurements

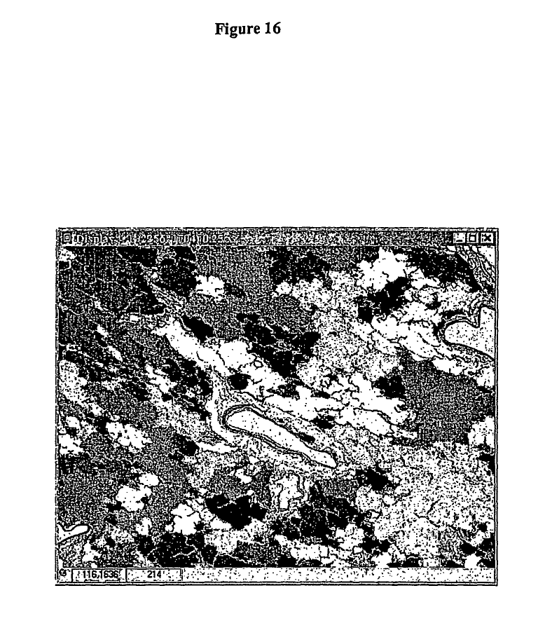

Due to the high capability of the image analysis software used, the S/V ratio can be directly determined from the image by perimeter and area measurements. According to Weibel (25) the S/V ratio is a function of the perimeter divided by the area. Perimeter and area measurements are carried out automatically, with each individual area being indicated with a different colour on the graphic display (FIG. 16). For each area the perimeter is also measured, and this results in a data list containing area and perimeter measurements for each region. The ‘b’ image is used to prevent the non-parenchyma components being measured as before. To prevent noise interfering with the data, any region with an area less than 100 pixels is not measured. To arrive at a S/V ratio, the following formula is used: 4×Total Perimeter π×Total Area.

The only disadvantage with this method could be the influence of edge effects. Regions touching the edge of the image have an unknown perimeter and area as the region is not completely observed. In this scenario an unbiased counting frame (26) is implemented whereby regions touching the top and left of the image are counted, and the regions touching the bottom and right of the image are excluded. However, due to the damage caused by the elastase in many images, regions are often large in size and exclusion would result in a large part of the image being excluded (FIG. 16). For this reason this approach was not adopted and all regions were included. Due to the size of the 3×3 image, edge effects have a minimal effect on the analysis.

2.7.3 Linear Mean Intercept (LMI)

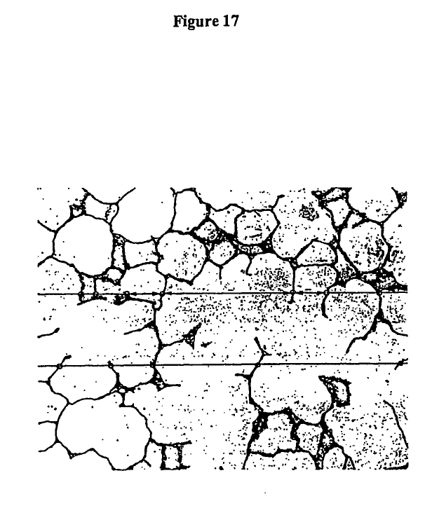

The LMI parameter is similar to the most commonly used morphometric parameter employed in analysis of emphysematous lung tissue, the Lm. The basis of the Lm is that a line of known length L, randomly overlaid on a section of lung will intersect the interalveolar septa m times (FIG. 17). If this is done a number of times (N), then the Lm=N×L/m giving the average length of an intercept (6) . This method however provides no information on the distribution of intercept length, and does not take into account the thickness of the alveolar walls. We therefore devised a method that uses the principles of the Lm but provides more complete data with improved sensitivity.

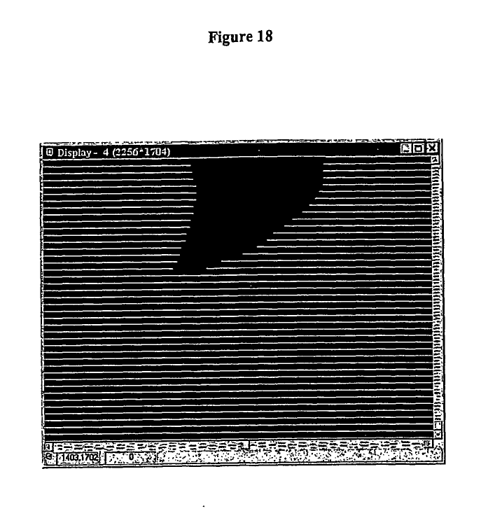

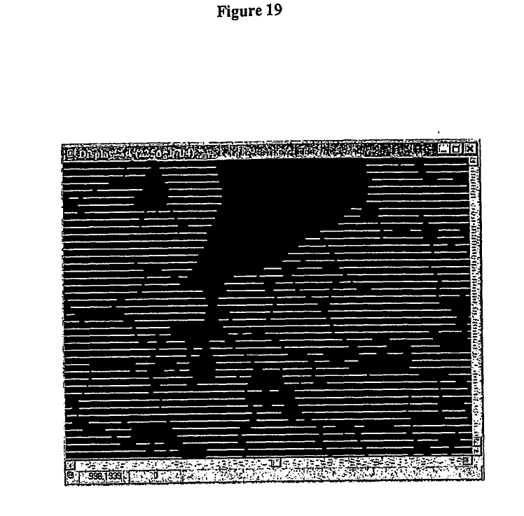

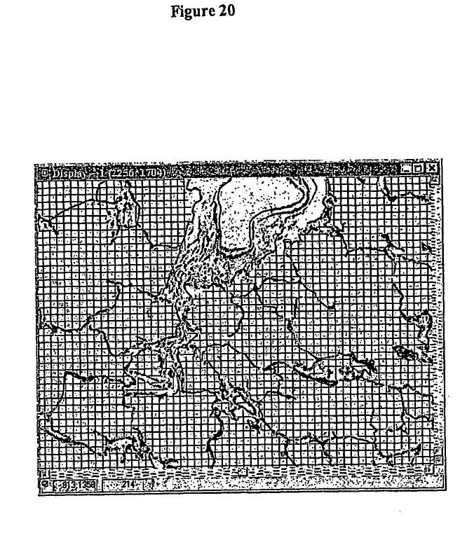

As with the Weibel graticule approach, the lines for the LMI were overlaid on the whole 3×3, first in the x direction, parallel lines 10 pixels apart, and then merged with the ‘b’ image to leave lines only covering parenchyma (FIG. 18). This parenchyma grid is then merged with the lung 3×3 (‘a’ image) resulting in an image containing many intercepts (FIG. 19). Each individual intercept longer than 10 pixels is measured and the corresponding value entered into the data list automatically. The grid is then drawn in the y-axis, merged with the ‘b’ and ‘a’ images and the measurements repeated. This process results in the lung image being analysed by a LMI grid containing many lines (FIG. 20). The data list typically contains several thousand values. This procedure is repeated for the other 3×3's and the LMI is calculated as the mean of all values measured. The data also allows the distribution of the intercept length to be examined.

2.7.4 Nodal Analysis

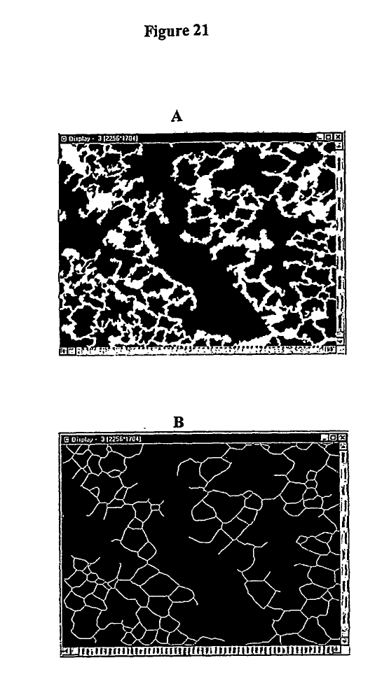

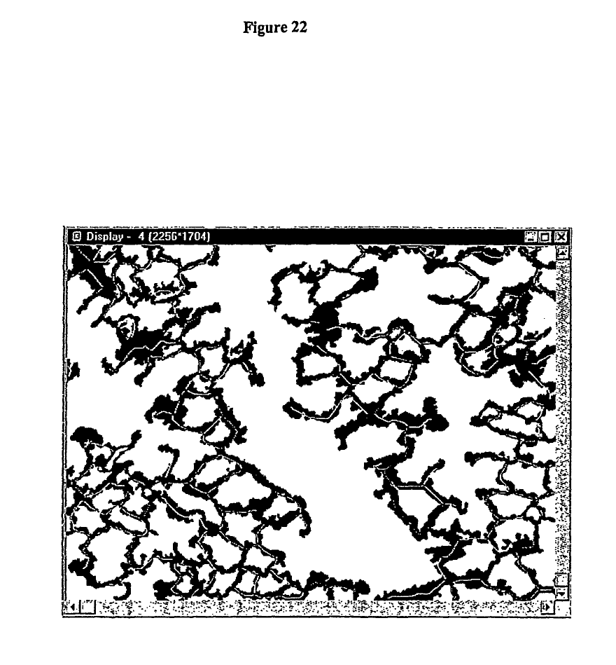

The S/V ratio (determined by either of the above methods) is influenced by changes in tissue architecture and airspace enlargement. The LMI measurements come solely from airspace measurements. The forth analysis parameter, nodal analysis, examines the tissue component of the lung. The binary lung structure image (‘a’ image) is first merged with the ‘b’ image to leave only lung parenchyma. The lung structure is then thinned down to one-pixel thick lines while preserving the lung skeleton, and smoothed to remove artefacts (FIG. 21). Using a convolution filter, the branching points are detected and then removed leaving only individual branches of the lung structure on the image (FIG. 22). The straight-line distance between the two ends of a branch (node-to-node distance) and the actual branch length (taking into account any curvature of the branch) are measured.

2.8 Statistical Data Analysis

Comparison of the two groups (normal and emphysematous lungs) was made using a non-parametric two-tailed Mann-Whitney group test using GraphPad Prism (version 3.0) software. Means quoted are ± sample standard deviation. Non-parametric two-tailed Spearman's rank correlations between parameters were also assessed using the Prism software.

3. Results

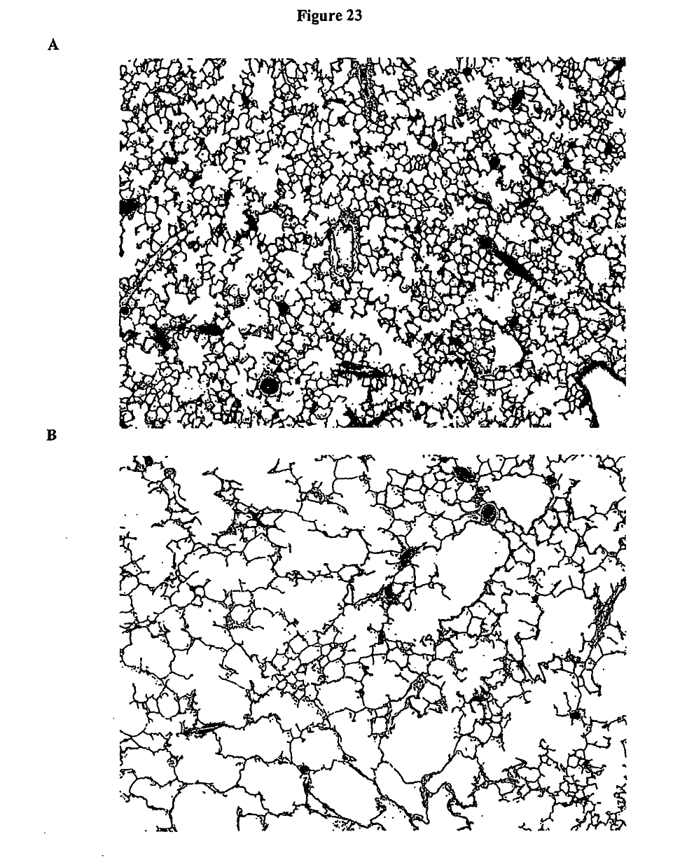

One slice for each lobe was examined with a total of 35 lobes being analysed (n=16 saline, n=19 PPE). The effect of PPE can be readily observed on a histological section (FIG. 23). Airspace enlargement is very prominent and is accompanied by disorganization and thinning of the alveolar walls. These observations have been reported previously (14). There was no evidence of increased numbers of inflammatory cells in sections of lung treated with PPE compared with those treated with saline.

3.1 Image Analysis Procedure

Capturing each lobe took on average between 5 and 10 minutes depending on the size of the lobe. 3×3 image selection, generation, and non-parenchyma component image generation required about 20 minutes for each lobe (six 3×3's). 3×3's for the complete study were generated and stored within two weeks of receiving the slides. The automated analysis was found to be very fast with each 3×3 being analysed and having the data recorded in less than 4 minutes. The data for the whole study was recorded and collated in about 15 hours. For comparison, the time taken for measurement of a single parameter from a section has been quoted in the literature as 45 minutes (21). All parameters analysed showed a significant difference between rats killed 28 days after intratracheal instillation of saline and age-matched rats killed 28 days after intratracheal instillation of PPE (Table 1).

3.2 Surface Area to Volume Ratio

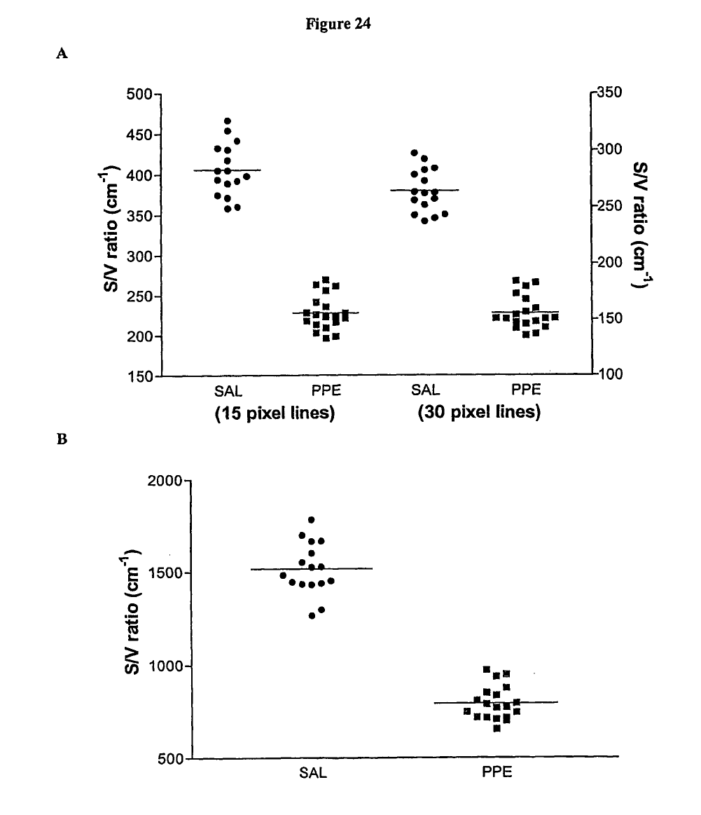

The instillation of PPE significantly (P<0.001) reduced the surface area to volume ratio when using either the Weibel graticule (15 or 30 pixel length lines) or the perimeter/area methodology (FIG. 24). The Weibel graticule with 15 pixel lines gave a mean S/V ratio in the PPE treated rats of 229 cm⁻¹±24 compared to 406 cm⁻¹±33 in the saline treated rats. Using 30 pixel lines the values for PPE and saline were 156 cm⁻¹±16 and 264 cm⁻¹±19 respectively. The values front the same groups differ with size of the Weibel graticule line due to this length being part of the S/V ratio calculation (see methods).

Despite the possible influence of edge effects, the S/V ratio determined by perimeter/area measurements was also significantly different between the two groups. As a result of the elastase treatment the S/V ratio was 798 cm⁻¹±96 compared to 1517 cm⁻¹±141 with saline.

3.3 Linear Mean Intercept (LMI)

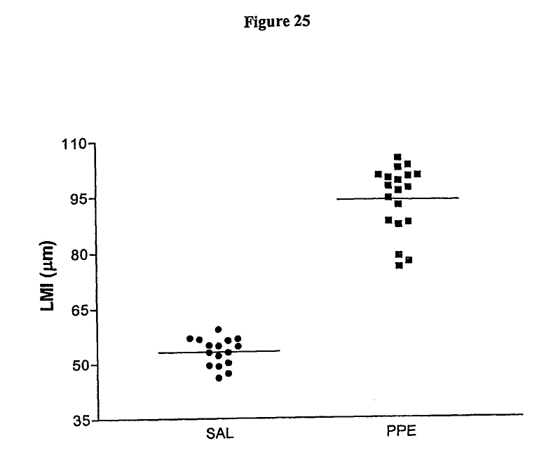

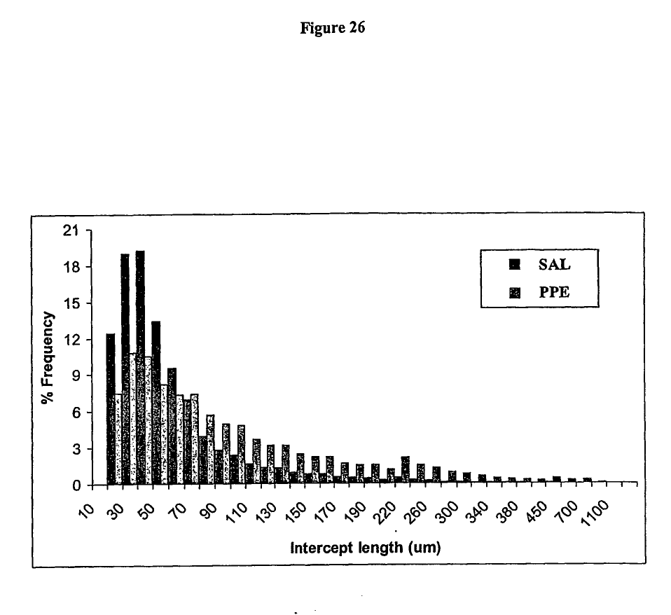

Instillation of PPE caused a significant increase (p<0.001) in mean LMI compared to saline treatment (FIG. 25) resulting in a 40 μm difference between the two groups (Table 1). The distribution of the intercept lengths was plotted (FIG. 26) and this illustrates the prominent changes in airspace size due to PPE instillation. There is a dramatic fall in the number of small airspaces and an increase in larger ones, resulting in a change in the ratio of large to small airspaces. Lungs exposed to PPE also had very large airspaces (intercepts above 350 μm in length) which were not present in lungs treated with saline.

3.4 Nodal Analysis

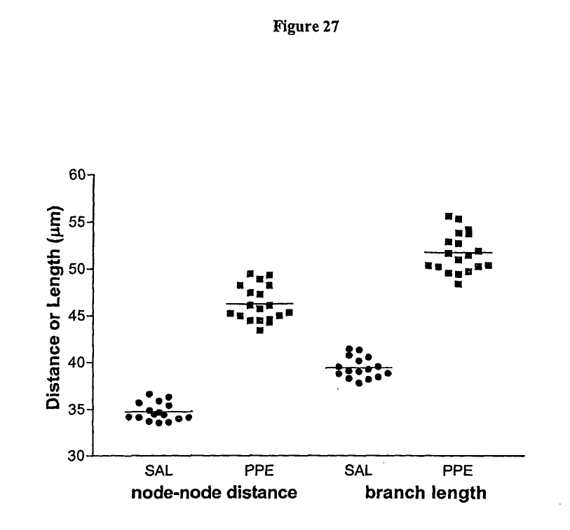

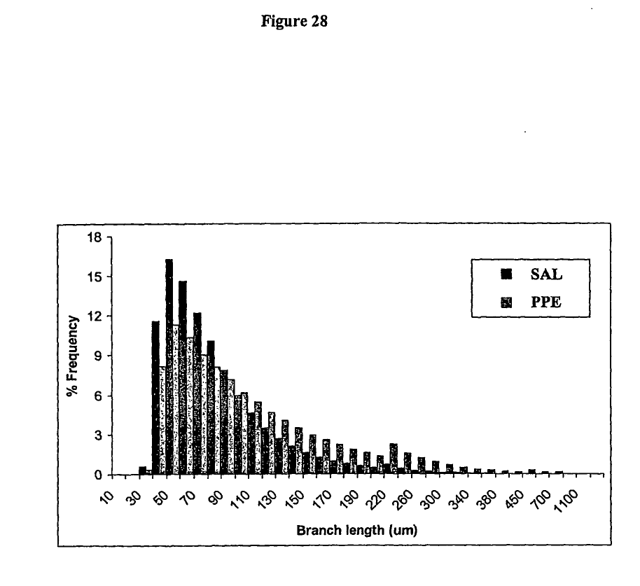

Average branch length and the average distance between nodes increased significantly following instillation of PPE (FIG. 27). Visual inspection of images showed that in PPE treated lungs the size of alveoli has increased, resulting in longer branch lengths compared to those treated with saline. As with LMI the frequency distribution curve (FIG. 28) shifted to the right following instillation of PPE. 3.5 Parameter Correlations

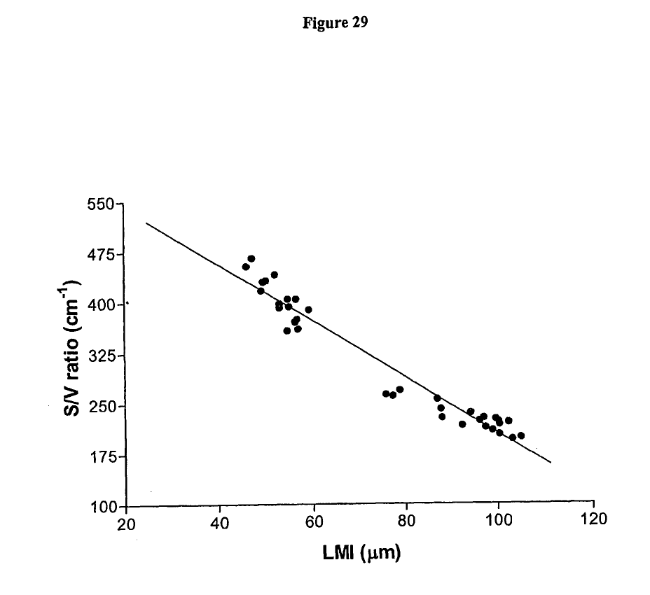

The S/V ratio and the Lm are inversely related. (27) and due to the similarity of the Lm to our LMI method we expected the LMI to correlate with S/V ratios measured. This is indeed the case (Table 2) with an r-value above 0.9 for each of the S/V ratios vs. LMI. The S/V ratio using the Weibel graticule (with 15 pixel lines) was plotted against LMI to illustrate this correlation (FIG. 29). Correlations for the other parameters have also been calculated (Table 2). All correlations show high significance (p<0.0001).

4. Discussion

In this work, we have adapted lung morphometric techniques described by others (6, 7, 25) to carry out computer-based image analysis of thin sections of lung presenting normal and emphysenatous morphology. Lung morphometry is an inherently labour intensive process but using computer automation techniques we have greatly reduced the time required to obtain quantitative data frown such studies. Moreover, the morphometric parameters that we have employed significantly detect emphysematous morphology in an elastase-induced model of emphysema.

4.1 Image Capture, Processing, and 3×3 Generation

Image capturing, using the mosaic methodology described here, has several advantages. Firstly, it is quick, taking between 5-10 minutes on average for each lobe, which can result in 150-300 fields being digitally captured and stored. This procedure is fully automated and requires little training for the user. Secondly, the mosaic process allows large areas of lung tissue to be analysed (and thus a larger number of observations made) by joining up adjacent fields to form larger images such as a 3×3. The Prior motorised stage allows precise movements (˜μm accuracy) to be made, enabling these 3×3 images to be created automatically.

Thirdly, once these 3×3 images are created and stored they can be easily retrieved in the future when other emphysema indicators may be analysed. These parameters could be alveolar attachments (AA) or airway dimension changes, which are considered to be indicators of emphysema (28, 29). Omission of non-parenchyma components from thin lung section image analysis has been described before (30) and aids sensitivity by preventing the morphometric quantitation of airways, blood vessels, and bronchi. Including these components in the analysis would interfere in the detection of features such as alveolar destruction and airspace enlargement specific to the parenchyma, which are characteristic of emphysema in humans and animal models (5, 14).

4.2 Lung Morphometry—Comparison with Literature Values

For any morphometric parameters to be compared across lung tissue studies the most important variable to be controlled is inflation. Quoted alveolar dimensions and lung volumes are only specific at certain pressures (27). For this reason, most researchers fix at a pressure approximate to the physiological state of inflation but variation will still be experienced. In addition different methods of fixation exist which affect physical dimensions of the lung. Caution must be applied when such comparisons are made. An obvious difference when comparing studies is that of species. Both rats and mice are used in animal models of emphysema but morphometric values cannot be directly compared as mice have smaller alveoli than rats (31) and thus lower Lm values at a given pressure.

Various morphometric parameters have been quoted in the literature for the measurement of emphysema from thin lung slices including Lm, S/V ratio, AA, and the destructive index (DI) (6, 12, 28, 32). Of these, the Lm is the most widely accepted. For this reason, we based one of our analysis parameters (LMI) on this technique.

Values for Lm and LMI from the same images will not be identical, as the Lm does not take into account alveolar wall thickness. For example, a line 100 μm in length intersected 4 times would give a Lm of 25 μm. The LMI however would be lower than this as part of the line would fall on tissue and so the actual length falling on airspace would measure perhaps 80 μm, resulting in an average LMI of 20 μm. Escolar et al. have used a computer-based technique similar to our LMI called alveolar chord length (23) which they measured alongside the conventional Lm. The alveolar chord length was indeed lower than the Lm from the same images.

Comparing Lm values from different studies with lungs fixed at the same pressure is still not straightforward. Magnification of the image affects Lm determination. Lm measurements are normally made by use of a cross hair viewed through the microscope eyepiece which overlays the image of the lung tissue. The relative thickness of these lines compared to that of the alveolar walls is dependent on magnification; the lower the magnification the thicker the line will be. This can lead to different Lm values being obtained from the same area of lung (7). This is why we made the grid lines in the LMI and S/V ratio analysis as thin as possible (single pixel thickness).

Age also has a prominent effect on lung dimensions. In humans and mammals, alveolar dimensions (and thus measurements such as the Lm) increase with age. In man this effect has been given the term ‘the senile lung’ (33), which presents significant airspace enlargement but is distinct from emphysema due to the lack of alveolar destruction. In rats, the Lm significantly differed by 12 μm between adulthood (16 weeks old) and middle age (56 weeks old) (34).

The final factor affecting Lm values across studies is that of shrinkage due to fixation, dehydration, embedding, and sectioning. Correction factors for these components are calculated by taking measurements of volumes or lengths during processing of the lung tissue so that the dimensions of the fresh lung can be estimated (27). Shrinkage was not corrected for in the study reported here. However, it is assumed that as all samples were processed together, shrinkage would be consistent.

Factors such as those above for the Lm must be given due consideration when comparing any morphometric technique across studies. However, the extent of morphological change between two groups (such as normal vs. emphysema) can be compared across studies, as the exact values are not required.

For this purpose the Lm and LMI can be compared (although the difference between groups with LMI will be slightly larger as alveolar thinning does take place in emphysematous lungs) to approximate the severity of emphysema with different treatments. The PPE protocol in this study was based on that used by Massaro et al. in a study demonstrating reversal of elastase-induced emphysema by retinoic acid (35). In the Massaro study the Lm increased from 74 to 96 μm compared to our LMI, which rose from 53 to 93 μm suggesting that the emphysema was more extensive in our study. Only the left lobe was analysed in our analysis compared to regions from all lobes in the Massaro study. It is possible that the damage was more prominent in the left lobe than other areas of the lung with this instillation method. Subtle differences in the [in vivo procedures between the two studies could also influence the instillation.

Comparisons of the S/V ratios obtained from the Weibel graticule method with those quoted in the literature are even more difficult to make since the length of the individual line is a major influence on the value obtained. As with the Lm, the magnification used will also have an effect on the value obtained. A study quoting S/V ratios for elastase treatment of rats similar to our experimental procedure could not be found in the literature. However, as a very rough guide the values we obtained for the saline treated rats (406 and 264 cm⁻¹) were not too far away from the S/V ratio of similar age saline treated rats in an inhibition study of alveolar septation. The lungs were inflated to the same pressure, fixed and processed in a similar manner to our study, but the magnification used was ×100 rather than ×300 (36). The researchers also made corrections for shrinkage in this study. The S/V ratio for these rats was 305 cm⁻¹. Another group carried out almost the same study but with rats of a slightly older age (37) and estimated an S/V ratio of 641 cm⁻¹. These results illustrate the variation in absolute values obtained using this method.

As far as we are aware S/V ratio measurements using perimeter/area methodology and nodal analysis parameters, have not been examined by others in the elastase-induced emphysema model, but when applied show excellent agreement with the other parameters discussed above (Table 2).

Provided that correct unbiased sampling of lung tissue slices is employed and the reference space is considered (lung volume)(9, 3 8, 26) the techniques described here provide a rapid, semi-automated image analysis procedure for obtaining accurate quantitative data to detect and quantify the degree of emphysema in animal models. This procedure, in tandem with lung function measurements, is suitable for use in the evaluation of therapeutic agents intended to prevent or reverse pathological features of emphysema.

TABLE 1
Data of lung morphometry obtained in PPE-treated and
saline-treated adult rat lungs by computerised
stereological methods.

| Parameter | Saline | PPE |
|---|---|---|
| Surface Area to Volume ratio | | |
| Weibel (15 pixel lines), cm⁻¹ | 406 ± 33 | 229 ± 24* |
| Weibel (30 pixel lines), cm⁻¹ | 264 ± 19 | 156 ± 16* |
| Perimeter/Area, cm⁻¹ | 1517 ± 141 | 798 ± 96* |
| LMI, μm | 53.1 ± 3.8 | 93.0 ± 9.5* |
| Node Analysis | | |
| Node to node distance | 34.8 ± 1.0 | 46.3 ± 1.9* |
| Branch Length | 39.4 ± 1.1 | 51.7 ± 2.1* |

Values are means + SD.
*p < 0.001<

TABLE 2
Non-parametric correlations between morphometric parameters
obtained in elastase-treated and saline treated rat lungs by
computer-based stereological methods.

| Group parameters | All lungs examined (n = 35) |
|---|---|
| S/V ratio (15) vs. LMI | r = 0.9571 (p < 0.0001) |
| S/V ratio (30) vs. LMI | r = 0.9742 (p < 0.0001) |
| S/V ratio (p/a) vs. LMI | r = 0.9852 (p < 0.0001) |
| S/V ratio (15) vs. S/V ratio (30) | r = 0.9922 (p < 0.0001) |
| S/V ratio (15) vs. S/V ratio (p/a) | r = 0.9445 (p < 0.0001) |
| S/V ratio (15) vs. Branch length | r = 0.8605 (p < 0.0001) |
| LMI vs. Branch length | r = 0.9148 (p < 0.0001) |
| LMI vs. Node-Node distance | r = 0.9092 (p < 0.0001) |

### REFERENCES

1) Weibel, E. R. Fractal geometry: a design principle for living organisms (1991).
Am. J. Physiol. 261, L361-L369.
2) Margraf, L. R., Tomashefski, J. F. J., Bruce, M. C. and Dahms, B. B. Morphometric analysis of the lung in bronchopulnlonary dysplasia (1991). Am. Rev. Respir. Dis.
143, 391-400.
3) Coxson, H. O., Hogg, J. C., Mayo, J. R., Behead, H., Whittall, K. P., Schwartz, D. A., Hartley, P. G., Calvin, J. R. , Wilson, J. S. and Hunninghake, G. W. Quantification of idiopathic pulmonary fibrosis using computed tomography and histology (1997). Am. J. Respir. Crit. Care Med. 155, 1649-1656.
4) Anderson, J. A. and Dunnill, M. S. Observations on the Estimation of the quantity of emphysema in the lungs by the point-sampling method (1965). Thorax 20, 462-466.
5) Snider, G. L., Kleinerman, J., Thurlbeck, W. M. and Bengali, Z. H. The definition of emphysema: Report of a National Heart, Lung, and Blood Institute, Division of Lung Diseases Workshop (1985). Am. Rev. Respir. Dis. 132, 182-185.
6) Dunnill, M. S. Quantitative methods in the study of pulmonary pathology (1962).
Thorax 17, 320-328.
7) Heemskerk-Gerritsen, B. A., Dijkman, J. H. and Ten Have-Opbroek, A. A.
Stereological methods: a new approach in the assessment of pulmonary emphysema (1996). Microsc. Res. Tech. 34, 556-562.
8) Thurlbeck, W. M. Measurement of pulmonary emphysema (1967).
Am. Rev. Respir. Dis. 95, 752-764.
9) Bolender, R. P., Hyde, D. M. and Dehoff, R. T. Lung morphometry: a new generation of tools and experiments for organ, tissue, cell, and molecular biology (1993). An; J Physiol 265, L521-L548.
10) Weibel, E. R., Kistler, G. S. alla Scherle, W. Practical stereological methods for morplometric cytology (1966). J. Cell Biol. 30, 23-38.
11) Blanco, L. N., Massaro, G. D. and Massaro, D. Alveolar dimensions and number: developmental and hormonal regulation (1989). Arn. J. Physiol. 257, L240-L247.
12) Wiebe, B. M. and Laursen, H. Lung morphometry by unbiased methods in emphysema: bronchial and blood vessel volume, alveolar surface area and capillarylength (1998). APMIS 106, 651-656.
13) Snider, G. L., Lucey, E. C. and Stone, P. J. Animal models of emphysema (1986).
Am. Rev. Respir. Dis. 133, 149-169.
14) Kaplan, P. D., Kuhn, C. and Pierce, J. A. The induction of emphysema with elastase. I. The evolution of the lesion and the influence of serum (1973).
J. Lab. Clin. Med. 82, 349-356.
15) Colombo, C. and Steinetz, B. G. Lung enzymes in emphysematous rats: effects of progestagens, antiphlogistics and metabolic inhibitors (1975).
Arch. Int. Pharmacodyn. Ther. 216, 86-96.
16) Snider, G. L. Emphysema: the first two centuries—and beyond. A historical overview, with suggestions for future research: Part 1 (1992).
Am. Rev. Respir. Dis. 146, 1334-1344.
17) Hautamaki, R. D., Kobayashi, D. K., Senior, R. M. and Shapiro, S. D. Requirement for macrophage elastase for cigarette smoke-induced emphysema in mice (1997).
Science 277, 2002-2004.
18) Ofulue, A. F., Ko, M. and Abboud, R. T. Time course of neutrophil and macrophage elastinolytic activities in cigarette smoke-induced emphysema (1998). An. J. Physiol. 275, L1134-L1144.
19) March, T. H., Barr, E. B., Finch, G. L., Hahn, F. F., Hobbs, C. H., Menache, M. G.
and Nikula, K. J. Cigarette smoke exposure produces more evidence of emphysema in B6C3F1 mice than in F344 rats (1999). Toxicol. Sci. 51, 289-299.
20) Diamond, L., Kimmel, E. C., Lai, Y. L. and Winsett, D. W. Augmentation of elastase-induced emphysema by cigarette smoke. Effects of reduced nicotine content (1988). Am. Rev. Respir. Dis. 138, 1201-1206.
21) Nagai, A., Yamawaki, I., Thurlbeck, W. M. and Takizawa, T. Assessment of lung parenchyma destruction by using routine histologic tissue sections (1989).
An. Rev. Respir. Dis. 139, 313-319.
22) Gillooly, M., Lamb, D. and Farrow, A. S. New automated technique for assessing emphysema on histological sections (1991). J Clin Pathol 44, 1007-1011. I 23) Escolar, J. D., Martinez, M. N., Rodriguez, F. J., Gonzalo, C., Escolar, M. A. and Roche, P. A. Emphysema as a result of involuntary exposure to tobacco smoke: morphometrical study of the rat (1995). Exp. Lung Res. 21, 255-273.
24) Weibel, E. R. Principles and methods for the morphometric study of the lung and other organs (1963). Lab. Invest. 12, 131-155.
25) Weibel, E. R. Stereological Methods (1979). London: Academic Press, 9-196.
26) Gundersen, H. J., Bendtsen, T. F., Korbo, L., Marcussen, N., Moller, A., Nielsen, K., Nyengaard, J. R., Pakkenberg, B., Sorensen, F. B., and Vesterby, A. Some new, simple and efficient stereological methods and their use in pathological research and diagnosis (1988). APM[IS 96, 379-394.
27) Weibel, E. R. Morphometric and stereological methods in respiratory physiology including fixation techniques (1984). Techniques in the Life Sciences P4/I, 1-35.
28) Saetta, M., Ghezzo, H., Kim, W. D., King, M., Angus, G. E., Wang, N. S., and Cosio, M. G. Loss of alveolar attachments in smokers. A morphometric correlate of lung function impairment (1985). Am. Rev. Respir. Dis. 132, 894-900.
29) Verbeken, E. K., Cauberghs, M. and van de Woestijne, K. P. Membranous bronchioles and connective tissue network of normal and emphysematous lungs (1996). T. Appl. Physiol. 81, 2468-2480.
30) Oldmixon, E. H., Butler, J. P., and Hoppin, F. G. Semi-automated measurement of true chord length distributions and moments by video microscopy and image analysis (1994). J. Microsc. 175 (Pt 1!, 60-69.
31) Tenny, S. M. and Remnlers, J. E. Comparative quantitative morphology of the mammalian lung: diffusing area (1963). Nature 197, 54-56.
32) Saetta, M., Shiner, R. J., Angus, G. E, Kim, W. D., Wang, N. S., King, M., Ghezzo, H. and Cosio, M. G. Destructive index: a measurement of lung parenchyma destruction in smokers (1985). Am. Rev. Respir. Dis. 131, 764-769.
33) Verbeken, E. K., Cauberghs, M., Mertens, I., Clement, J., Lauweryns, J. M. and van de Woestijue, K. P. The senile lung. Comparison with normal and emphysematous lungs. 1. Structural aspects (1992). Chest 101, 793-799.
34) Escolar, J. D., Gallego, B., Tejero, C., and Escolar, M. A. Changes occurring with increasing age in the rat lung: morphometrical study (1994). Anat Rec 239, 287-296.
35) Massaro, G. D. and Massaro, D. Retinoic acid treatment abrogates elastase-induced pulmonary emphysema in rats (1997). Nat. Med. 3, 675-677.
36) Massaro, D., Teich, N., Maxwell, S., Massaro, G. D., and Whitney, P. Postnatal development of alveoli. Regulation and evidence for a critical period in rats (1985). J. Clin. Invest. 76, 1297-1305.
37) Sahebjami, H. and Domino, M. Effects of postnatal dexamethasone treatment on development of alveoli in adult rats (1989). Exp. Lung Res. 15, 961-973.
38) Cruz Orive, L. M. and Weibel, E. Sampling designs for stereology (1981). J Microsc 122, 235-257.

All publications mentioned in the above specification, and references cited in said publications, are herein incorporated by reference. Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in molecular biology or related fields are intended to be within the scope of the following claims.

What is claimed is:

1. A method of analysing a sample image representing a sample of lung, said method comprising:
forming an applied graticule image corresponding in size to said sample image and excluding areas corresponding to non-parenchyma within said sample image;
superimposing said applied graticule image on said sample image;
determining one or more parameters dependent upon which portions of said applied graticule image fall in airspace and which portions of said applied graticule image fall upon tissue; and
calculating a parameter indicative of a surface to volume ratio for said sample of lung from said one or more parameters.

2. The method of claim 1, wherein said applied graticule image is formed by the steps of:
identifying non-parenchyma areas of said sample image corresponding to tissue other than parenchyma;
forming a full frame graticule image corresponding in size to said sample image; and
removing from said full frame graticule image areas corresponding to said non parenchyma areas to forth said applied graticule image.

3. The method of claim 2, wherein said step of identifying comprises the steps of:
searching said sample image for areas of tissue greater than a predetermined size;
classifying said areas of tissue greater than a predetermined size as non parenchyma areas.

4. The method of claim 3, wherein said of identifying comprises the step of:
receiving user input defining areas as non-parenchyma areas.

5. The method of claim 1, wherein said parameters include one or more of: a number Iₐ of graticule lines of said applied graticule image intersecting tissue; and a number Pₐ of ends of graticule lines on airspace.

6. The method of claim 5, wherein said surface to volume ratio is proportional to:
(Iₐ*2)/(Pₐ*L_{T})
where L_{T} represents a length of a graticule line.

7. Apparatus for analysing a sample image representing a sample of lung, said apparatus comprising data processing logic operable to perform data processing operations in accordance with a method, wherein the method comprises:
forming an applied graticule image corresponding in size to said sample image and excluding areas corresponding to non-parenchyma within said sample image;
superimposing said applied graticule image on said sample image;
determining one or more parameters dependent upon which portions of said applied graticule image fall in airspace and which portions of said applied graticule image fall upon tissue; and
calculating a parameter indicative of a surface to volume ratio for said sample of lung from said one or more parameters.

8. A method of analysing a sample image representing a sample of lung, said method comprising:
identifying non-parenchyma areas of said sample image corresponding to tissue other than parenchyma;
searching within areas of said sample image corresponding to parenchyma for bounded areas of airspace surrounded by tissue;
measuring a perimeter value and an area value for said bounded areas; and
calculating a parameter indicative of a surface to volume ratio for said sample of lung from said perimeter value and said area value.

9. The method of claim 8, wherein said step of identifying comprises the steps of:
searching said sample image for areas of tissue greater than a predetermined size;
classifying said areas of tissue greater than a predetermined size as non parenchyma areas

10. The method of claim 9, wherein said of identifying comprises the step of: receiving user input defining areas as non-parenchyma areas.

11. The method of claim 8, wherein bounded areas having an area smaller than a predetermined threshold value are excluded from said step of calculating.

12. The method of claim 8, wherein perimeter value is a total perimeter value P_{T} for said bounded areas upon which said calculation is based and said area value is a total area value A_{T} for said bounded areas upon which said calculation is based.

13. The method of claim 12, wherein said surface to volume ratio is proportional to:
(4*P_{T})/(π*A_{T})

14. A method of analysing a sample image representing a sample of lung, said method comprising:
forming an applied lines image of a plurality of substantially parallel lines and corresponding in size to said sample image and excluding areas corresponding to non parenchyma within said sample image;
superimposing said applied lines image on said sample image;
determining where lines of said applied lines image intersect tissue within said sample image to form intersected line segments;
and calculating a parameter indicative a mean length of said intersected line segments.

15. The method of claim 14, further comprising repeating said steps of forming, superimposing, determining and calculating for an further applied lines images of lines running in a different direction.

16. The method of claim 15, wherein said different direction is substantially orthogonal.

17. The method of claim 14, further comprising calculating a parameter indicative of a distribution of lengths of said intersected line segments.

18. The method of claim 14, wherein said applied lines image is formed by the steps of:
identifying non-parenchyma areas of said sample image corresponding to tissue other than parenchyma;
forming a full frame lines image corresponding in size to said sample image;
and removing from said full frame lines image areas corresponding to said non-parenchyma areas to form said applied lines image.

19. The method of claim 18, wherein said step of identifying comprises the steps of:
searching said sample image for areas of tissue greater than a predetermined size;
classifying said areas of tissue greater than a predetermined size as non parenchyma areas.

20. The method of claim 19, wherein said of identifying comprises the step of: receiving user input deeming areas as non-parenchyma areas.
